(19) United States
(12) Patent Application Publication
(10) Pub. No.: US 2018/0320624 A1
(43) Pub. Date: Nov. 8, 2018

(54) DEPOSIT ESTIMATION DEVICE AND COMBUSTION SYSTEM CONTROL DEVICE

(71) Applicant: DENSO CORPORATION, Kariya-city, Aichi-pref. (JP)

(72) Inventors: Atsunori OKABAYASHI, Kariya-city (JP); Shinya HOSHI, Kariya-city (JP)

(21) Appl. No.: 15/773,588

(22) PCT Filed: Oct. 18, 2016
(86) PCT No.: PCT/JP2016/080763

§ 371 Date: May 4, 2018

(30) Foreign Application Priority Data
Nov. 12, 2015 (JP) 2015-222315

(51) Int. Cl. F02D 41/26; F02B 77/04; F02B 77/08

(52) U.S. Cl. CPC F02D 41/263; F02D 2200/0612; F02B 77/083; F02B 77/04

(57) ABSTRACT

A deposit estimation device includes an acquisition unit, a soot calculation unit, an adhesion index calculation unit, and a deposit amount estimation unit. The acquisition unit acquires the mixing ratio of each of a plurality of types of molecular structures contained in a fuel to be used for combustion of a combustion system. The soot calculation unit calculates a soot generation index, representing how likely a soot component is to be generated due to combustion, based on the mixing ratio acquired by the acquisition unit. The adhesion index calculation unit calculates an adhesion index, representing how likely a soluble organic component generated due to combustion is to adhere, based on a value detected by a sensor for detecting the property of a fuel or the mixing ratio acquired by the acquisition unit. The deposit amount estimation unit estimates a deposit amount of a soluble organic component that has adhered to a predetermined portion of the combustion system, based on the soot generation index calculated by the soot calculation unit and the adhesion index calculated by the adhesion index calculation unit.

### CROSS REFERENCE TO RELATED APPLICATION

This application is based on Japanese Patent Application No. 2015-222315 filed on Nov. 12, 2015, the disclosure of which is incorporated herein by reference.

### TECHNICAL FIELD

The present disclosure relates to a deposit estimation device that estimates a deposit amount of a soluble organic component that has adhered to a predetermined portion of a combustion system.

### BACKGROUND ART

A soluble organic component (SOF component) generated due to combustion in a combustion system is highly tacky. Therefore, there is the concern that an SOF component may adhere to and deposit in a portion of the combustion system, the portion being exposed to exhaust gas, which may result in a malfunction of the combustion system. In order to prevent such a malfunction from occurring, it is necessary to reduce the deposit at a timing when the deposit amount of the SOF component reaches a predetermined amount. It is necessary, for example, after an internal combustion engine is stopped, to perform control in which the SOF component is shaken down by opening and closing a valve to which the SOF component has adhered, to burn out the deposit, or to control a combustion state such that the amount of the SOF component in exhaust gas is reduced.

In order to perform such control at the minimum necessary frequencies, it is important to accurately estimate the deposit amount. For example, Patent Document 1 discloses a technique in which the amount (deposit amount) of an SOF component depositing around the injection hole of a fuel injection valve is estimated based on a fuel injection amount from the fuel injection valve, the atmospheric temperature and pressure of the injection hole, an NOx concentration in exhaust gas, and the like.

However, the generation amount and viscosity of the SOF component differ depending on what type of fuel is used. For example, when a fuel that generates a highly viscous SOF component is used, the SOF component is more likely to adhere, and hence the deposit amount increases. In the method of estimating the deposit amount described in Patent Document 1, it is not taken into consideration what type of fuel is used, and hence the estimation accuracy is low.

### RELATED ART DOCUMENT

### Patent Document

PATENT DOCUMENT 1: JP 2010-111293 A

### SUMMARY OF INVENTION

An object of the present disclosure is to provide both a deposit estimation device that can estimate a deposit amount with high accuracy and a combustion system control device.

According to an embodiment of the present disclosure, the deposit estimation device includes: an acquisition unit that acquires a mixing ratio of each of a plurality of types of molecular structures included in a fuel to be used for combustion of a combustion system; a soot calculation unit that calculates a soot generation index, representing how likely a soot component is to be generated due to combustion, based on the mixing ratio acquired by the acquisition unit; an adhesion index calculation unit that calculates an adhesion index, representing how likely a soluble organic component generated due to combustion is to adhere, based on a value detected by a sensor for detecting a property of a fuel or the mixing ratio acquired by the acquisition unit; and a deposit amount estimation unit that estimates a deposit amount of a soluble organic component that has adhered to a predetermined portion of the combustion system, based on the soot generation index calculated by the soot calculation unit and the adhesion index calculated by the adhesion index calculation unit.

According to another embodiment of the present disclosure, the combustion system control device includes: an acquisition unit that acquires a mixing ratio of each of a plurality of types of molecular structures included in a fuel to be used for combustion of a combustion system; a soot calculation unit that calculates a soot generation index, representing how likely a soot component is generated due to combustion, based on the mixing ratio acquired by the acquisition unit; an adhesion index calculation unit that calculates an adhesion index, representing how likely a soluble organic component generated due to combustion is to adhere, based on a value detected by a sensor for detecting a property of a fuel or the mixing ratio acquired by the acquisition unit; a deposit amount estimation unit that estimates a deposit amount of a soluble organic component that has adhered to a predetermined portion of the combustion system, based on the soot generation index calculated by the soot calculation unit and the adhesion index calculated by the adhesion index calculation unit; and a control unit that controls the operation of the combustion system so as to reduce a deposit amount in accordance with the deposit amount estimated by the deposit amount estimation unit.

A particulate component (PM) contained in the exhaust gas of the combustion system is mainly composed of soot, but the soot, remaining as it is, is in a dry state not having a tackiness. When such dry soot is taken into unburned fuel or lubricating oil contained in the exhaust gas, or when a polycyclic aromatic component, a soot precursor, remains unburned, a soluble organic component referred to as a tacky SOF component is generated. This SOF component adheres and deposits to form a deposit. Therefore, as a fuel is more likely to generate soot components due to combustion, a larger amount of SOF components are generated, and hence a deposit amount increases. In addition, as a fuel generates an SOF component whose viscosity is higher, the SOF component is more likely to adhere and deposit, and hence a deposit amount increases. That is, a deposit amount should be able to be estimated with high accuracy only by obtaining, with respect to a fuel currently in use, information (soot generation index) on whether the fuel is likely to generate a soot component and information (adherence index) on whether the fuel generates a highly viscous SOF component.

The present inventors have obtained the knowledge that “the soot generation index and the adhesion index can be estimated from the mixing ratio of each of a plurality of types of molecular structures contained in a fuel.” For example, the soot component is formed with paraffin components or naphthene components, each having a large number of linear chains or side chains, subjected to polymerization through thermal decomposition or decomposition by radicals to change to aromatic components, and with the aromatic components subjected to lamination through polymerization and condensation. Therefore, as a fuel contains larger mixing ratios of aromatic components and components (hereinafter referred to as aromatic variable components) that can be changed to aromatic components as described above, the fuel is more likely to generate a soot component, that is, the fuel has a higher soot generation index. As a fuel contains, for example, a larger mixing ratio of aromatic components each having a large number of carbon atoms among the aromatic components, the volatility of an SOF component becomes lower, and hence the fuel generates a SOF component whose viscosity is likely to be high, that is, the fuel has a high adhesion index.

According to the present disclosure, the soot generation index is calculated based on the mixing ratio of each of a plurality of types of molecular structures, based on these knowledge. Also, the adhesion index is calculated based on a value detected by a sensor for detecting a property of a fuel or based on the above mixing ratio. Then, the deposit amount of an SOF component is estimated based on both the indices thus calculated. Therefore, the deposit amount can be estimated with high accuracy.

### BRIEF DESCRIPTION OF DRAWINGS

The above and other objects, characteristics, and advantages of the present disclosure will become more apparent from the following detailed description with reference to the accompanying drawings:

FIG. 1 is a view for explaining a combustion system control device according to a first embodiment of the disclosure and a combustion system of an internal combustion engine to which the device is applied;

FIG. 2 is a view for explaining an ignition delay time;

FIG. 3 is a view for explaining a relationship among a plurality of ignition delay times, combustion conditions that are a combination of combustion environment values representing flammability, and mixing amounts of various components;

FIG. 4 is a view showing a relationship between a property line representing a change in the ignition delay time caused due to an in-cylinder oxygen concentration and the molecular structure species of fuel;

FIG. 5 is a view showing a relationship between a property line representing a change in the ignition delay time caused due to an in-cylinder temperature and the molecular structure species of fuel;

FIG. 6 is a view showing a relationship between a property line specified based on an ignition delay time and the mixing ratio of a molecular structure species;

FIG. 7 is a flowchart showing procedures for estimating a deposit amount and controlling the operation of a combustion system based on the estimation result;

FIG. 8 is a view for explaining a determinant for calculating a soot generation index X in a first embodiment;

FIG. 9 is a view for explaining a determinant for calculating an adhesion index Y in the first embodiment;

FIG. 10 is a graph showing the relationship among the soot generation index X, the adhesion index Y, and a deposit amount M in the first embodiment; and

FIG. 11 is a graph showing the relationship among the soot generation index X, the adhesion index Y, and the deposit amount M in a third embodiment of the present disclosure.

### DESCRIPTION OF EMBODIMENTS

Hereinafter, a plurality of embodiments for carrying out the invention will be described with reference to the views. In each embodiment, parts corresponding to the items described in the preceding embodiment are denoted by the same reference numerals, and duplicated description may be omitted. In each embodiment, when only part of a configuration is described, the previously described other embodiments can be referred to and applied to the other parts of the configuration.

### First Embodiment

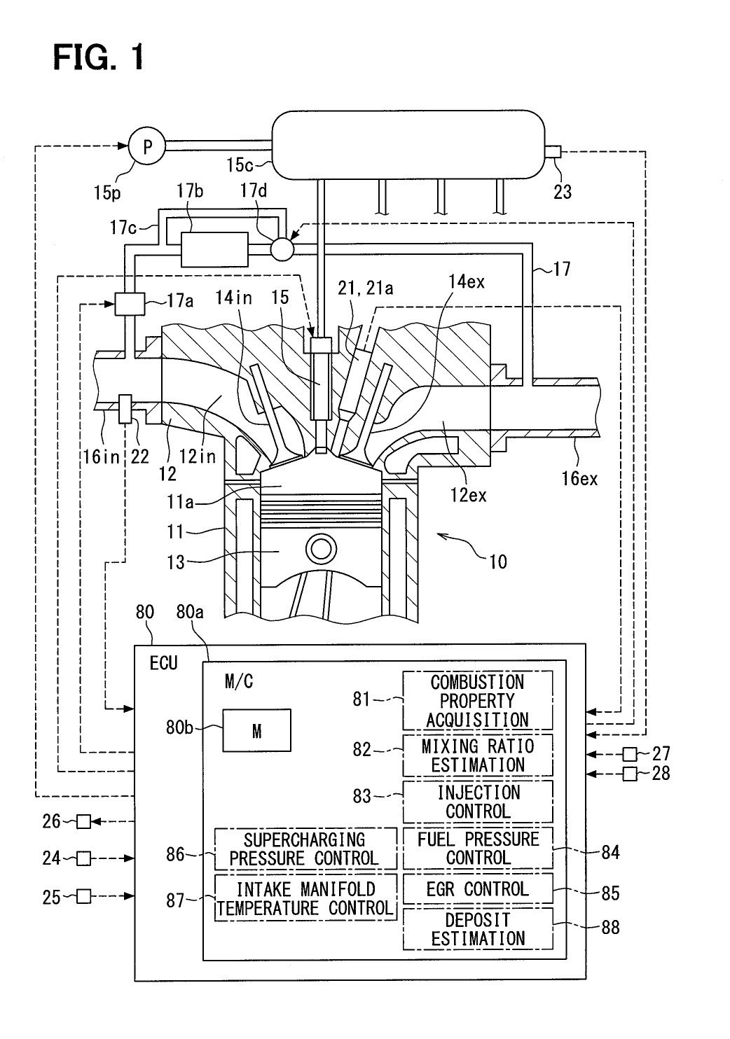

A combustion system control device according to the present embodiment is provided by an electronic control unit (ECU) 80 shown in FIG. 1. The ECU 80 includes a microcomputer 80a, an unshown input processing circuit and an output processing circuit, and the like. The microcomputer 80a includes an unshown central processing unit (CPU) and a memory 80b. With the CPU executing a predetermined program stored in the memory 80b, the microcomputer 80a controls the operations of a fuel injection valve 15, a fuel pump 15p, an EGR valve 17a, a temperature control valve 17d, a supercharging pressure regulator 26, and the like, which are included in a combustion system. Through these controls, the combustion state of an internal combustion engine 10 included in the combustion system is controlled to be a desired state. The combustion system and the ECU 80 are mounted in a vehicle, and the vehicle travels by using the output of the internal combustion engine 10 as a driving source.

An internal combustion engine 10 includes a cylinder block 11, a cylinder head 12, a piston 13, and the like. An intake valve 14in, an exhaust valve 14ex, a fuel injection valve 15, and an in-cylinder pressure sensor 21 are attached to the cylinder head 12. A density sensor 27 for detecting the density of a fuel and a dynamic viscosity sensor 28 for detecting the dynamic viscosity of a fuel are attached to the portion forming a fuel passage such as a common rail 15c or to a fuel tank.

The fuel pump 15p pumps the fuel in the fuel tank to the common rail 15c. The fuel in the common rail 15c is stored therein in a state in which the pressure of which is maintained at a target pressure Ptrg with the ECU 80 controlling the operation of the fuel pump 15p. The common rail 15c distributes the accumulated fuel to the fuel injection valve 15 of each cylinder. The fuel injected from the fuel injection valve 15 mixes with the intake air in a combustion chamber 11a to form an air-fuel mixture, and the air-fuel mixture is compressed by the piston 13 and self-ignites. The internal combustion engine 10 is a compression self-ignition type diesel engine, and light oil is used as fuel.

The fuel injection valve 15 is configured by accommodating, in the body, an electromagnetic actuator and a valve body. When an ECU 80 powers on the electromagnetic actuator, the electromagnetic attraction force of the electromagnetic actuator opens a leak passage of an unshown back pressure chamber, and the valve body opens with a decrease in back pressure and an injection hole formed in the body is opened, whereby a fuel is injected from the injection hole. When the electromagnetic actuator is powered off, the valve body closes, whereby the fuel injection is stopped.

An intake pipe 16in and an exhaust pipe 16ex are respectively connected to an intake port 12in and an exhaust port 12ex formed in the cylinder head 12. An EGR pipe 17 is connected to each of the intake pipe 16in and the exhaust pipe 16ex, so that EGR gas that is part of exhaust gas refluxes into the intake pipe 16in through the EGR pipe 17. An EGR valve 17a is attached to the EGR pipe 17. The aperture of the EGR pipe 17 is controlled with the ECU 80 controlling the operation of the EGR valve 17a, whereby the flow rate of the EGR gas is controlled.

In addition, an EGR cooler 17b for cooling the EGR gas, a bypass pipe 17c, and a temperature control valve 17d are attached to the upstream portion of the EGR valve 17a of the EGR pipe 17. The bypass pipe 17c forms a bypass flow path through which the EGR gas bypasses the EGR cooler 17b. The temperature control valve 17d adjusts a ratio between the EGR gas flowing through the EGR cooler 17b and the EGR gas flowing through the bypass flow path and finally adjusts the temperature of the EGR gas flowing into the intake pipe 16in by adjusting the aperture of the bypass flow path. The intake air flowing into the intake port 12in contains external air (fresh air) flowing into from the intake pipe 16in and the EGR gas. Therefore, adjusting the temperature of the EGR gas by the temperature control valve 17d corresponds to adjusting an intake manifold temperature that is the temperature of the intake air flowing into the intake port 12in.

The combustion system includes an unshown supercharger. The supercharger has a turbine to be attached to the exhaust pipe 16ex and a compressor to be attached to the intake pipe 16in. When the turbine rotates by the flow velocity energy of the exhaust, the compressor rotates by the rotational force of the turbine, whereby the fresh air is compressed and supercharged by the compressor. The above-described supercharging pressure regulator 26 is a device for changing the capacity of the turbine, and the turbine capacity is adjusted with the ECU 80 controlling the operation of the supercharging pressure regulator 26, whereby the supercharging pressure by the compressor is controlled.

Detection signals detected by various sensors, such as the in-cylinder pressure sensor 21, an oxygen concentration sensor 22, a rail pressure sensor 23, a crank angle sensor 24, and an accelerator pedal sensor 25, are inputted to the ECU 80.

The in-cylinder pressure sensor 21 outputs a detection signal corresponding to the pressure (in-cylinder pressure) of the combustion chamber 11a. The in-cylinder pressure sensor 21 has a temperature detection element 21a in addition to a pressure detection element, and also outputs a detection signal corresponding to the temperature (in-cylinder temperature) of the combustion chamber 11a. The oxygen concentration sensor 22 is attached to the intake pipe 16in, and outputs a detection signal corresponding to the oxygen concentration of the intake air. The intake air to be detected is a mixture of fresh air and the EGR gas. The rail pressure sensor 23 is attached to the common rail 15c, and outputs a detection signal corresponding to the pressure (rail pressure) of the accumulated fuel. The crank angle sensor 24 outputs a detection signal corresponding to the rotation speed of a crankshaft rotationally driven by the piston 13, that is, to the rotation number (engine rotation number) of the crankshaft per unit time. The accelerator pedal sensor 25 outputs a detection signal corresponding to the depression amount (engine load) of an accelerator pedal to be depressed by a vehicle driver.

Based on these detection signals, the ECU 80 controls the operations of the fuel injection valve 15, the fuel pump 15p, the EGR valve 17a, the temperature control valve 17d, and the supercharging pressure regulator 26. Thereby, a fuel injection start timing, an injection amount, an injection pressure, an EGR gas flow rate, an intake manifold temperature, and a supercharging pressure are controlled.

A microcomputer 80a, while controlling the operation of the fuel injection valve 15, functions as an injection control unit 83 that controls a fuel injection start timing, an injection amount, and the number of injection stages related to multi-stage injection. The microcomputer 80a, while controlling the operation of a fuel pump 15p, functions as a fuel pressure control unit 84 that controls an injection pressure. The microcomputer 80a, while controlling the operation of an EGR valve 17a, functions as an EGR control unit 85 that controls an EGR gas flow rate. The microcomputer 80a, while controlling the operation of a temperature control valve 17d, functions as an intake manifold temperature control unit 87 that controls an intake manifold temperature. The microcomputer 80a, while controlling the operation of a supercharging pressure regulator 26, functions as a supercharging pressure control unit 86 that controls a supercharging pressure.

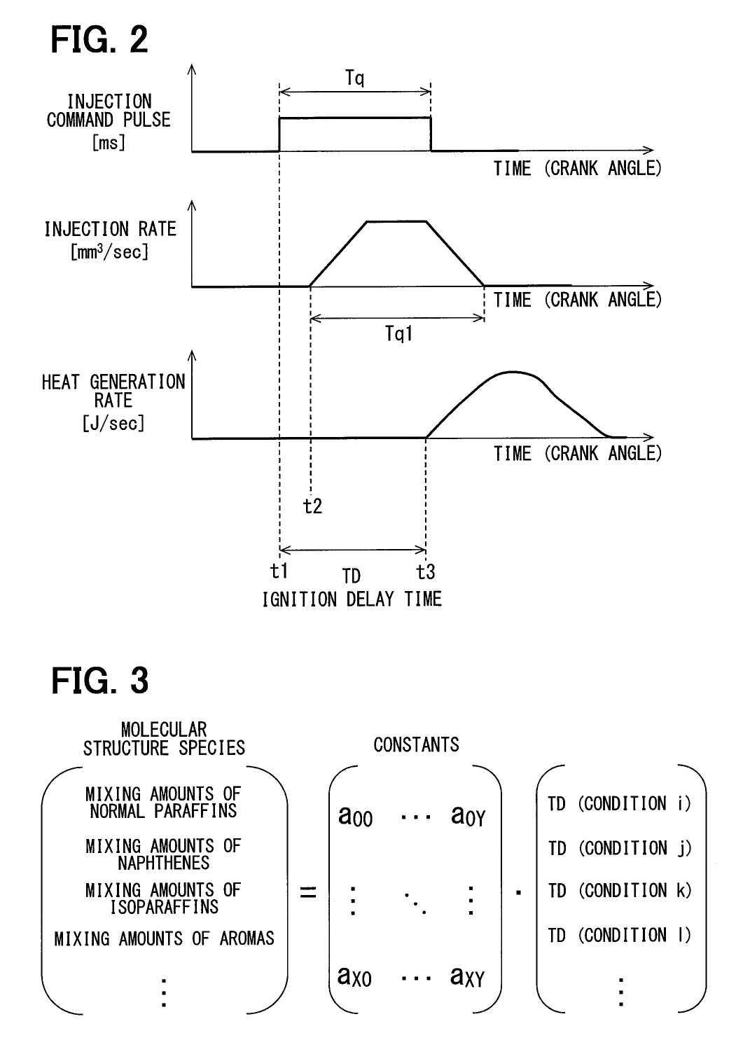

The microcomputer 80a also functions as a combustion property acquisition unit 81 that acquires a detected value (combustion property value) of a physical quantity related to combustion. The combustion property value according to the present embodiment is an ignition delay time TD shown in FIG. 2. The upper graph in FIG. 2 shows a pulse signal outputted from the microcomputer 80a. Powering the fuel injection valve 15 is controlled in accordance with the pulse signal. Specifically, the powering is started at a pulse-on timing t1, and is continued for a pulse-on period Tq. In short, an injection start timing is controlled by a pulse-on timing. In addition, an injection period is controlled by the pulse-on period Tq, which controls an injection amount.

The middle graph in FIG. 2 shows a change in the injection state of fuel from the injection hole, the change being generated as a result of the fact that the valve body opens and closes in accordance with the pulse signal. Specifically, a change in the injection amount (injection rate) of fuel injected per unit time is shown. As shown in the graph, there is a time lag between the timing t1 at which the powering is started and a timing t2 at which injection is actually started. There is also a time lag between a timing at which the powering is ended and a timing at which the injection is actually stopped. A period Tq1 for which the injection is actually being performed is controlled by the pulse-on period Tq.

The lower graph in FIG. 2 shows a change in the combustion state of the injected fuel in the combustion chamber 11a. Specifically, a change in a heat amount (heat generation rate) per unit time is shown, the change being caused with a mixture of the injected fuel and the intake air self-igniting and burning. As shown in the graph, there is a time lag between the timing t2 at which the injection is started and a timing t3 at which combustion is actually started. In the present embodiment, the time between the timing t1 at which powering is started and the timing t3 at which combustion is started is defined as the ignition delay time TD.

The combustion property acquisition unit 81 estimates the timing t3 at which combustion is started based on a change in the in-cylinder pressure detected by the in-cylinder pressure sensor 21. Specifically, a timing at which the in-cylinder pressure suddenly rises during a period for which a crank angle rotates by a predetermined amount after the piston 13 reaches a top dead center, is estimated as a combustion start timing (i.e., timing t3). The ignition delay time TD is calculated based on this estimation result by the combustion property acquisition unit 81. The combustion property acquisition unit 81 further acquires various states (i.e., combustion conditions) during combustion for each combustion. Specifically, at least one of an in-cylinder pressure, an in-cylinder temperature, an intake oxygen concentration, an injection pressure, and air-fuel mixture flow velocity is acquired as a combustion environment value.

These combustion environment values are parameters representing the flammability of a fuel, and it can be said that each of the in-cylinder pressure just before combustion, the in-cylinder temperature just before combustion, the intake oxygen concentration, the injection pressure, and the air-fuel mixture flow velocity increases to a higher level, the air-fuel mixture is more likely to self-ignite and burn. As the in-cylinder pressure and in-cylinder temperature just before combustion, for example, the values, detected at the timing t1 at which powering the fuel injection valve 15 is started, may be used. The in-cylinder pressure is detected by the in-cylinder pressure sensor 21, the in-cylinder temperature by a temperature detection element 21a, the intake oxygen concentration by an oxygen concentration sensor 22, and the injection pressure by a rail pressure sensor 23. The air-fuel mixture flow velocity is the flow velocity of the air-fuel mixture in the combustion chamber 11a just before combustion. Since this flow velocity becomes higher as the engine rotation number becomes larger, it is calculated based on the engine rotation number. The combustion property acquisition unit 81 stores the acquired ignition delay time TD in the memory 80b in association with a combination of the combustion environment values (combustion conditions) related to the combustion.

The microcomputer 80a also functions as a mixing ratio estimation unit 82 that estimates mixing ratios of various components contained in a fuel based on a plurality of the combustion property values detected under different combustion conditions. The mixing amounts of various components are calculated, for example, by substituting the ignition delay times TD for respective different combustion conditions into the determinant shown in FIG. 3. The mixing ratios of various components are calculated by dividing the respective calculated mixing amounts by the total amount.

The matrix on the left side of FIG. 3 is x rows and 1 column, and the numerical values of this matrix represent the mixing amounts of various components. The various components are components classified according to the types of molecular structures. The types of the molecular structures include normal paraffins, isoparaffins, naphthenes, and aromas.

The matrix on the left side of the right side is x rows and y columns, and the numerical values of this matrix represent constants determined based on the tests conducted in advance. The matrix on the right side of the right side is y rows and 1 column, and the numerical values of this matrix represent the ignition delay times TD acquired by the combustion property acquisition unit 81. For example, the numerical value of the first row and first column is the ignition delay time TD(condition i) acquired under a combustion condition i including a predetermined combination of the combustion environment values, and the numerical value of the second row and first column is the ignition delay time TD(condition j) acquired under a combustion condition j. Between the combustion conditions i and j, all of the combustion environment values are set to be different from each other. In the following description, an in-cylinder pressure, an in-cylinder temperature, an intake oxygen concentration, and an injection pressure related to the combustion condition i are set to P(condition i), T(condition i), O₂(condition i), and Pc(condition i), respectively. An in-cylinder pressure, an in-cylinder temperature, an intake oxygen concentration, and an injection pressure related to the combustion condition j are set to P(condition j), T(condition j), O₂(condition j), and Pc(condition j), respectively.

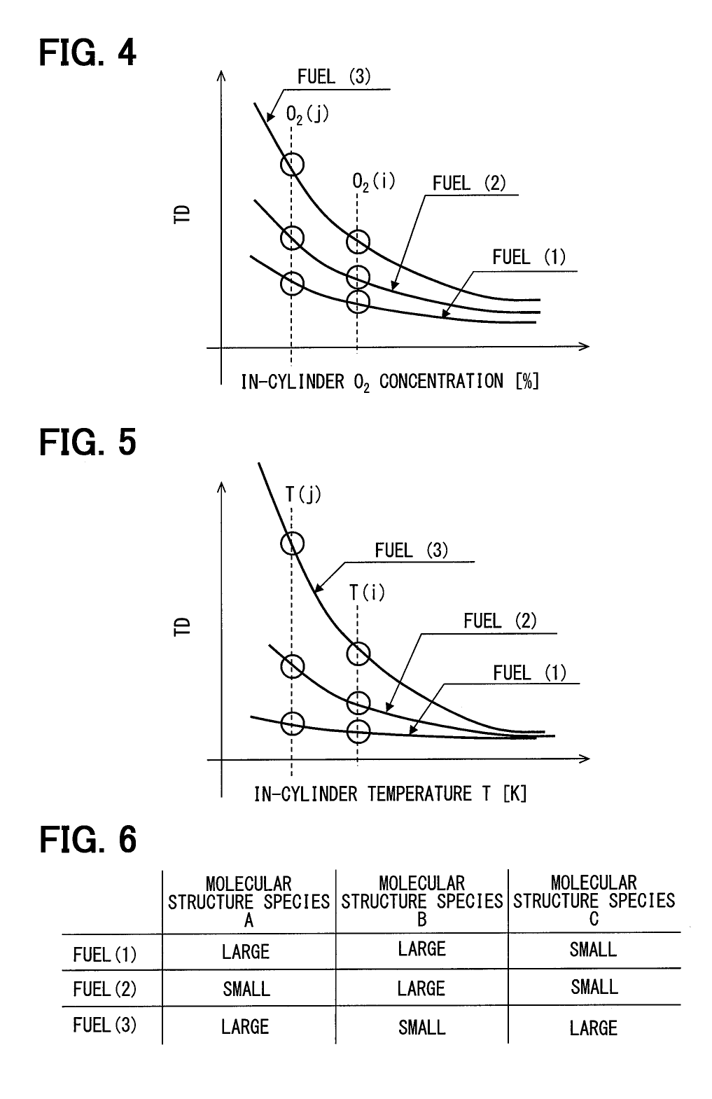

Next, the theory that the mixing amount of each molecular structure species can be calculated by substituting the ignition delay times TD for the respective combustion conditions into the determinant of FIG. 3 will be described with reference to FIGS. 4, 5, and 6.

As the concentration of oxygen (in-cylinder oxygen concentration) contained in an air-fuel mixture related to combustion is higher, the mixture is more likely to self-ignite, and hence the ignition delay time TD becomes shorter, as shown in FIG. 4. Three solid lines (1), (2), and (3) in the view are property lines each showing the relationship between the in-cylinder oxygen concentration and the ignition delay time TD. However, this property line differs depending on fuel. Strictly speaking, the property line differs depending on the mixing ratio of each molecular structure species contained in fuel. Therefore, by detecting the ignition delay time TD occurring when the in-cylinder oxygen concentration is O₂ (condition i), it can be estimated which molecular structure species is contained. In particular, by comparing the ignition delay time TD occurring when the in-cylinder oxygen concentration is O₂ (condition i) with the ignition delay time TD occurring when the in-cylinder oxygen concentration is O₂ (condition j), the mixing ratio can be estimated with higher accuracy.

Similarly, as the in-cylinder temperature is higher, the air-fuel mixture is more likely to self-ignite, and hence the ignition delay time TD becomes shorter, as shown in FIG. 5. Three solid lines (1), (2), and (3) in the view are property lines each showing the relationship between the in-cylinder temperature and the ignition delay time TD. However, this property line differs depending on fuel, and strictly speaking, it differs depending on the mixing ratio of each molecular structure species contained in fuel. Therefore, by detecting the ignition delay time TD occurring when the in-cylinder temperature is B1, it can be estimated which molecular structure species is contained. In particular, by comparing the ignition delay time TD occurring when the in-cylinder temperature is T (condition i) with the ignition delay time TD occurring when the in-cylinder temperature is T (condition j), the mixing ratio can be estimated with higher accuracy.

Similarly, as the injection pressure is higher, oxygen is more likely to be taken in and the air-fuel mixture is more likely to self-ignite, and hence the ignition delay time TD becomes shorter. Strictly speaking, a sensitivity differs depending on the mixing ratio of each molecular structure species contained in fuel. Therefore, by detecting the ignition delay time TD occurring when the injection pressure is different, the mixing ratio can be estimated with higher accuracy.

In addition, a molecular structure species having a high influence on the property line related to the in-cylinder oxygen concentration (see FIG. 4) is different from a molecular structure species having a high influence on the property line related to the in-cylinder temperature (see FIG. 5). Thus, molecular structure species having high influences on the property lines each related to each of a plurality of combustion conditions are different from each other. Therefore, based on a combination of the ignition delay times TD acquired by setting a combination of a plurality of the combustion environment values (combustion conditions) to different values, it can be estimated with high accuracy which molecular structure species is mixed in a large amount, as shown in, for example, FIG. 6. In the following description, the in-cylinder oxygen concentration is referred to as a first combustion environment value, the in-cylinder temperature as a second combustion environment value, and a property line related to the first combustion environment value as a first property line, and a property line related to the second combustion environment value as a second property line.

A molecular structure species A shown in FIG. 6 is one having a high influence on a property line (hereinafter referred to as the first property line) related to the in-cylinder oxygen concentration as the first combustion environment value. A molecular structure species B is one having a high influence on a property line (hereinafter referred to as the second property line) related to the in-cylinder temperature as the second combustion environment value, and a molecular structure species C is one having a high influence on a third property line related to a third combustion environment value. It can be said that as a change in the ignition delay time TD becomes larger with respect to a change in the first combustion environment value, a larger amount of the molecular structure species A is mixed. Similarly, it can be said that as a change in the ignition delay time TD becomes larger with respect to a change in the second combustion environment value, a larger amount of the molecular structure species B is mixed, and it can be said that as a change in the ignition delay time TD becomes larger with respect to a change in the third combustion environment value, a larger amount of the molecular structure species C is mixed. Therefore, the mixing ratios of the molecular structure species A, B, and C can be estimated for each of the different fuels (1), (2), and (3).

Next, the processing of the program executed by the combustion property acquisition unit 81 will be described. This processing is executed each time when the below-described pilot injection is commanded. Injection may be controlled such that a fuel is injected from the same fuel injection valve 15 more than once (multi-stage injection) during one combustion cycle. Of these multiple times of injection, the injection in which the largest injection amount is set is referred to as main injection, and the injection just before that as pilot injection.

First, the combustion property acquisition unit 81 calculates the ignition delay time TD related to the pilot injection by estimating the combustion start timing t3 based on the value detected by the in-cylinder pressure sensor 21, as described above. Next, the ignition delay time TD is stored in the memory 80b in association with a combination of a plurality of the combustion environment values (combustion condition).

Specifically, a numerical range within which each combustion environment value can fall is divided into a plurality of regions, so that a combination of the regions of a plurality of the combustion environment values is preset. For example, the ignition delay time TD(condition i) shown in FIG. 3 represents an ignition delay time TD acquired when the regions of P(condition i), T(condition i), O₂(condition i), and Pc(condition i) are combined. Similarly, the ignition delay time TD(condition j) represents an ignition delay time TD acquired when the regions of P(condition j), T(condition j), O₂(condition j), and Pc(condition j) are combined.

When there is a high possibility that another fuel may have mixed with the fuel stored in the fuel tank when a user has supplied the other fuel, it is assumed that the mixing ratios of molecular structure species have been changed, and the values of the estimated mixing amounts are reset. For example, when an increase in the remaining fuel amount is detected, during the stop of the operation of the internal combustion engine 10, by a sensor that detects the amount of the fuel remaining in the fuel tank, the above values are reset.

The combustion property acquisition unit 81 calculates the mixing amount of each molecular structure species by substituting the ignition delay times TD into the determinant of FIG. 3. The number of columns of the matrix representing constants is changed in accordance with the number of samples, that is, with the number of the rows of the matrix on the right side of the right side of the determinant. Alternatively, regarding the ignition delay times TD that have not been acquired, preset nominal values are substituted into the matrix of the ignition delay times TD. The mixing ratio of each molecular structure species is calculated based on the mixing amount of each molecular structure species thus calculated.

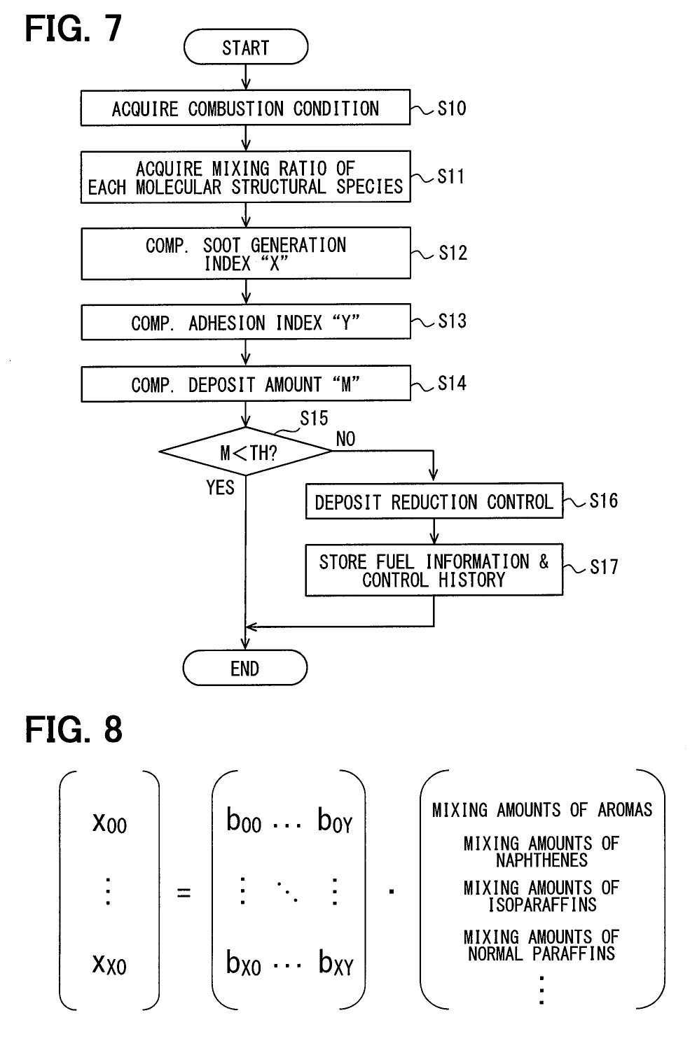

The microcomputer 80a also functions as a deposit amount estimation unit 88 that estimates the deposit amount of an SOF component that has adhered to a predetermined portion of the combustion system based on the mixing ratio of each molecular structure species. The method of estimating a deposit amount M will be described in detail later with reference to FIGS. 7 to 10. Specific examples of the predetermined portion to which the SOF component, a soluble organic component, is to adhere include the EGR valve 17a, an EGR cooler 17b, the temperature control valve 17d, a portion around the injection hole of the fuel injection valve 15, the intake valve 14in, the exhaust valve 14ex, and the like. In short, the predetermined portion means a portion of the combustion system that is exposed to exhaust gas.

As described above, the microcomputer 80a also functions as the injection control unit 83, the fuel pressure control unit 84, the EGR control unit 85, the supercharging pressure control unit 86, and the intake manifold temperature control unit 87. These control units set target values based on an engine rotation number, an engine load, an engine cooling water temperature, and the like, and perform feedback control such that control objects become the target values. Alternatively, these control units perform open control with contents corresponding to the target values. Herein, the “combustion system” is configured to include the internal combustion engine 10 and the above control objects.

The injection control unit 83 controls (injection control) the injection start timing, the injection amount, and the number of injection stages by setting the pulse signal in FIG. 2 such that the injection start timing, the injection amount, and the number of injection stages become target values. The number of injection stages means the number of injection related to the above-described multi-stage injection. Specifically, the on-time (powering time) and the pulse on rising timing (powering start timing) of a pulse signal corresponding to the target values are stored in advance on a map. Then, a powering time and a powering start timing, corresponding to the target values, are acquired from the map such that the pulse signal is set.

In addition, an output torque obtained by injection, and emission state values such as a NOx amount and a smoke amount are stored. Then, in setting the target values based on an engine rotation number, an engine load, and the like in the next and subsequent injection, the target values are corrected based on the values stored as described above. In short, feedback control is performed by correcting the target values such that the deviations between the actual output torque and emission state values and the desired output torque and emission state values are made zero.

The fuel pressure control unit 84 controls the operation of a metering valve that controls the flow rate of the fuel sucked into the fuel pump 15p. Specifically, the operation of the metering valve is feedback-controlled based on the deviation between the actual rail pressure detected by the rail pressure sensor 23 and a target pressure Ptrg (i.e., target value). As a result, a discharge amount per unit time, the discharge being performed by the fuel pump 15p, is controlled, and the operation of the metering valve is controlled such that the actual rail pressure becomes the target value (i.e., fuel pressure control).

The EGR control unit 85 sets the target value of an EGR amount based on an engine rotation number, an engine load, and the like. The EGR amount is controlled by controlling the aperture of the EGR valve 17a (EGR control) based on this target value. The supercharging pressure control unit 86 sets the target value of a supercharging pressure based on an engine rotation number, an engine load, and the like. The supercharging pressure is controlled by controlling the operation of the supercharging pressure regulator 26 (supercharging pressure control) based on this target value. The intake manifold temperature control unit 87 sets the target value of an intake manifold temperature based on an outside air temperature, an engine rotation number, an engine load, and the like. The intake manifold temperature is controlled by controlling the aperture of the temperature control valve 17d (intake manifold temperature control) based on this target value.

Further, the target values set by the above-described various control units are changed by the later-described deposit reduction control in accordance with the deposit amount M estimated in accordance with a mixing ratio. Processing procedures for executing this correction by the microcomputer 80a will be described below with reference to FIG. 7. This processing is repeatedly executed at predetermined intervals during the operation period of the internal combustion engine 10.

In Step S10 in FIG. 7, the combustion condition just before combustion occurs in the combustion chamber 11a, that is, the respective various combustion environment values described above are acquired. For example, at least one of an in-cylinder pressure, an in-cylinder temperature, an intake oxygen concentration, an injection pressure, and an air-fuel mixture flow velocity is acquired as the combustion environment value.

In the following Step S11, the mixing ratio estimated by the mixing ratio estimation unit 82 is acquired. That is, the mixing ratio of each of the molecular structure species shown on the left side of FIG. 3 is acquired. In the following Step S12, a soot generation index X, representing how likely a soot component is to be generated due to combustion, is calculated based on the mixing ratio acquired in Step S11. The soot generation index X is calculated, for example, by substituting the mixing amount (i.e., mixing ratio) of each molecular structure species contained per unit amount of a fuel into the determinant shown in FIG. 8. The soot generation indices X00 . . . XX0 for respective combustion environment values are calculated, for example, by substituting the mixing ratio of each molecular structure species into the determinant shown in FIG. 8. The matrix on the left side of the right side of FIG. 8 is x rows and y columns, and the numerical values b00, b01 . . . bxy of this matrix represent constants determined for the respective combustion environment values based on the tests conducted in advance. The matrix on the right side of the right side is y rows and 1 column. Among the calculated X vectors, a value corresponding to the combustion environment value is set to be the final soot generation index X. These numerical values are values estimated by the mixing ratio estimation unit 82.

Herein, how likely a soot component is to be generated (degree of generation) differs for each of different fuels with different mixing ratios of various components contained in the fuels, even if the fuel has similar fuel properties such as cetane number. In the present embodiment, an index representing a degree of soot generation is referred to as a soot generation index X, and as the value of the soot generation index X is larger, the degree of soot generation is larger. Among the molecular structure species contained in a fuel, there are components that greatly influence the soot generation index X and components that do not significantly influence it. In view of such a degree of influence, the soot generation index X is calculated based on the mixing ratio of each molecular structure species.

As described above, the main component of PM contained in the exhaust gas is soot, and the soot is formed with a large number of aromatic components subjected to polymerization through thermal decomposition or decomposition by radicals and then to lamination. This polymerization reaction occurs with a fuel containing aromatic components exposed to a high temperature environment. Therefore, the soot is generated from the fuel injected into the combustion chamber 11a just before combustion. However, most of the generated soot is burned in the combustion chamber 11a just after being formed and disappears. The soot remaining without being burned is discharged from the combustion chamber 11a. The soot thus discharged is the main component of PM in the exhaust smoke. To be precise, the above soot generation index X represents how likely the soot, existing in the combustion chamber 11a just before combustion, is to increase. As a fuel has the higher soot generation index X, the amount of soot existing just before combustion is larger, and hence the amount of soot remaining without being burned becomes larger.

Paraffin components or naphthene components, each having a large number of linear chains or side chains, may be subjected to polymerization through thermal decomposition or decomposition by radicals to change to aromatic components. Components that can change to aromatic components in this way are referred to as aromatic variable components. Then, the aromatic component generated by the change of an aromatic variable component and the aromatic component originally contained in a fuel are subjected to lamination through polymerization and condensation, whereby a soot component is formed. This polymerization reaction occurs particularly with a fuel containing aromatic components exposed to a high temperature environment. Therefore, a soot component is generated from the fuel injected into the combustion chamber 11a just before combustion. Therefore, as the mixing ratio of aromatic components, of the mixing ratios of the respective molecular structure species acquired in Step S11, is larger, the soot generation index X becomes higher. In addition, the above-described aromatic variable component can change to an aromatic component just before combustion, and hence as the mixing ratio of aromatic variable components, of the mixing ratios of the respective molecular structure species acquired in Step S11, is larger, the soot generation index X becomes higher.

In view of these knowledge, the soot generation index X is estimated to be a higher value in Step S12, as the mixing ratios of aromatic components and aromatic variable components are larger. In detail, a weighting coefficient representing the degree of influence of aromatic components on the soot generation index X is set to be larger than that representing the degree of influence of aromatic variable components on the soot generation index X.

Among the aromatic variable components, for an aromatic variable component that is more likely to change to an aromatic component, a weighting coefficient is set to be larger. Specific examples of the aromatic variable components include, for example, naphthene components, isoparaffin components, normal paraffin components, and the like. Since naphthene components, isoparaffin components, and normal paraffin components are less likely to change to aromatic components in this order, the weighting coefficients are set to be smaller in this order.

Among the naphthene components, naphthene components each having a structure having two or more of cyclic structures are more likely to change to aromatic components. Therefore, a weighting coefficient for naphthene components each having a structure having two or more of cyclic structures is set to be larger than that for naphthene components each having a structure having less than two of cyclic structures.

Among the isoparaffin components, isoparaffin components, each having a structure having carbon atoms whose number is smaller than the average number of carbon atoms of a plurality of types of components contained in a fuel, are more likely to change to aromatic components. Therefore, a weighting coefficient for isoparaffin components each having a structure having carbon atoms whose number is smaller than the average number of carbon atoms is set to be larger than that for isoparaffin components each having a structure having carbon atoms whose number is equal to or larger than the average number of carbon atoms.

The types of molecular structures related to the substitution into the determinant of FIG. 8 include both aromatic variable components such as normal paraffins, isoparaffins, and naphthenes and aromas. The naphthene components are substituted by being classified into naphthenes each having a structure having two or more of cyclic structures and naphthenes each having a structure having less than two of cyclic structures. Among the naphthene components, naphthene components, each having a structure having two or more of cyclic structures, are particularly likely to change to aromatic components. Therefore, a weighting coefficient for the naphthene components each having a structure having two or more of cyclic structures is set to be larger than that for the naphthene components each having a structure having less than two of cyclic structures. Herein, the naphthenes each having a structure having less than two of cyclic structures are less likely to change to aromas than the naphthenes each having a structure having two or more of cyclic structures, and hence substitution of them into the determinant may be omitted.

The isoparaffin components are substituted by being classified into isoparaffins each having a structure having a small number of carbon atoms and isoparaffins each having a structure having a large number of carbon atoms. Specifically, the above classification is made by calculating an average number of carbon atoms of a plurality of types of components contained in a fuel and based on whether the number of carbon atoms of the relevant isoparaffins is smaller than the average number of carbon atoms. Among the isoparaffin components, isoparaffin components, each having a structure having carbon atoms whose number is smaller than the average number of carbon atoms of a plurality of types of components contained in the fuel, are particularly likely to change to aromatic components. Therefore, a weighting coefficient for the isoparaffin components each having a structure having carbon atoms whose number is smaller than the average number of carbon atoms is set to be larger than that for the isoparaffin components each having a structure having carbon atoms whose number is equal to or larger than the average number of carbon atoms. Herein, the isoparaffins each having a structure having a large number of carbon atoms are less likely to change to aromas than the isoparaffins each having a structure having a small number of carbon atoms, and hence substitution of them into the determinant may be omitted.

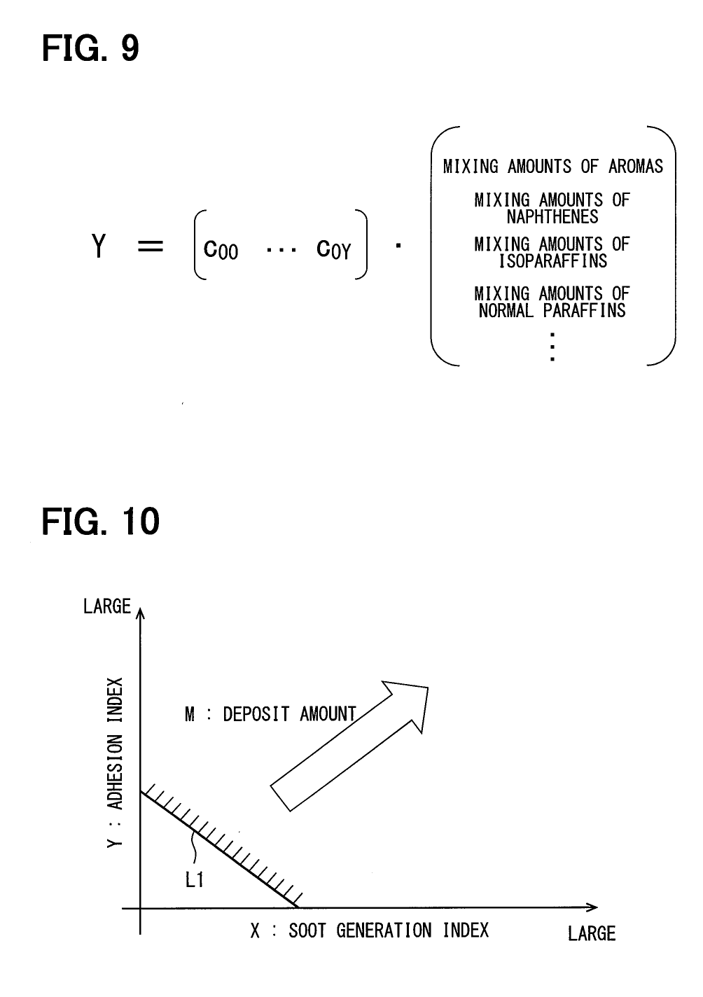

Returning to the description of FIG. 7, an adhesion index Y, representing how likely an SOF component generated due to combustion is to adhere, is calculated, in the following Step S13, based on the mixing ratio acquired in Step S11. The adhesion index Y is calculated, for example, by substituting the mixing amount (mixing ratio) of each molecular structure species contained per unit amount of fuel into the determinant shown in FIG. 9. The adhesion index Y is calculated, for example, by substituting the mixing ratio of each molecular structure species into the determinant shown in FIG. 9. The matrix on the left side of the right side of FIG. 9 is 1 row and y columns, and is a matrix having, for example, numerical values c00, c01 . . . C0y. These numerical values c00, c01 . . . C0y are constants determined based on the tests conducted in advance. The matrix on the right side of the right side is y rows and 1 column, and the numerical values of this matrix are ones estimated by the mixing ratio estimation unit 82.

Herein, how likely an SOF component is to adhere (degree of adhesion) differs for each of different fuels with different mixing ratios of various components contained in the fuels, even if the fuel has similar fuel properties such as cetane number. In the present embodiment, an index representing a degree of adhesion is referred to as an adhesion index Y, and as the value of the adhesion index Y is larger, the degree of adhesion of an SOF component is larger. Among the molecular structure species contained in a fuel, there are components that greatly influence the adhesion index Y and components that do not significantly influence it. In view of such a degree of influence, the adhesion index Y is calculated based on the mixing ratio of each molecular structure species.

Specifically, a fuel is more likely to vaporize, the viscosity of an SOF component becomes higher. More strictly, an SOF component is more likely to vaporize, the viscosity of the SOF component becomes higher. And, as the viscosity of an SOF component is higher, the adhesion index Y becomes higher and the deposit amount M is more likely to increase.

The average number of carbon atoms of molecular structure species can be calculated based on the mixing ratios of various components. It can be assumed that as the average number of carbon atoms is larger, a fuel has a distillation property in which the boiling point is higher and the volatility is lower, and for example, the temperature at which 50% of a fuel vaporizes, that is, a distillation property T50 can be estimated from the average number of carbon atoms. Then, assuming that as the estimated average number of carbon atoms is smaller, a fuel is more likely to vaporize, the adhesion index Y is set to a lower value.

Further, the degree of influence of an SOF component on the viscosity differs depending on molecular structure species. For example, the degree of influence of an SOF component on the viscosity becomes smaller in the order of a polycyclic aroma, a monocyclic aroma, a polycyclic naphthene, a normal paraffin, and a isoparaffin, and hence the weighting coefficients are set to be smaller in this order. In short, the mixing ratio of each molecular structure species correlates with the adhesion index Y, and hence the adhesion index Y can be calculated from the mixing ratio.

In the following Step S14, the deposit amount M is calculated based on the soot generation index X calculated in Step S12 and the adhesion index Y calculated in Step S13. Specifically, the deposit amount (unit deposit amount) for every predetermined time, which is calculated based on the soot generation index X and the adhesion index Y, is integrated every time when the operation time of the internal combustion engine 10 elapses the predetermined time, whereby the value of the deposit amount M is updated. In integrating in this way, the value to be integrated may be changed depending on the history of the combustion conditions acquired in Step S10. For example, the amount of deposits to adhere to the EGR valve 17a is changed such that as the amount of EGR that passes through an EGR pipe 17 per unit time is larger, the unit deposit amount is made larger, whereby the integration is made. Alternatively, the amount of deposits to adhere to the fuel injection valve 15 and the EGR valve 17a is changed such that assuming that as an in-cylinder temperature is lower, a volatilization amount is smaller, the unit deposit amount is made larger, whereby the integration is made. Alternatively, when a fuel is burned under a combustion condition in which an oxygen concentration is lower, the amount of the generated SOF component becomes smaller, and hence the unit deposit amount may be corrected to be smaller, whereby the integration may be made.

In FIG. 10, the horizontal axis represents the soot generation index X and the vertical axis represents the adhesion index Y, and as the values of both the indices are larger, the deposit amount M becomes larger as indicated by the arrow in the view. Therefore, the relationship between the deposit amount M and both the indices shown in FIG. 10 is acquired in advance by tests or the like, and stored, in the state of a map or the like, in the microcomputer 80a, and the deposit amount M may be calculated, in Step S14, from both the indices by referring to the map.

A boundary line L1 in FIG. 10 indicates the lower limit range where soot is generated. The unit deposit amount is regarded as zero in a range where both the indices are smaller than the boundary line L1. In a range where both the indices are larger than the boundary line L1, the deposit amount M is calculated to be larger as the value of the soot generation index X is larger and as the value of the adhesion index Y is larger. In short, the deposit amount M becomes larger as both the indices are larger. Even if the value of the soot generation index X is large, the deposit amount M becomes small when the value of the adhesion index Y is small, and even if the value of the adhesion index Y is large, the deposit amount M becomes small when the value of the soot generation index X is small. In the range where both the indices are larger than the boundary line L1, a unit deposit amount Z is calculated based on an arithmetic expression of Z=a·X·Y. The “a” in the arithmetic expression is a coefficient set in accordance with the above-described history of combustion conditions and environmental conditions such as EGR amount, in-cylinder temperature, and the like.

A fuel, having, for example, a large mixing ratio of aromatic components, has a higher soot generation index X. Of the aromatic components, an aromatic component, having a large number of carbon atoms, has a higher adhesion index Y than an aromatic component having a small number of carbon atoms. That is, there is the tendency that as the aromatic components, each having a large number of carbon atoms are contained, are contained in a larger amount, both the soot generation index X and the adhesion index Y become higher and the deposit amount M becomes larger. Specifically, there is the tendency that as aromatic components, each having a larger number of carbon atoms than the average number of carbon atoms of a plurality of types of components contained in a fuel, are contained in a larger amount in the fuel, the deposit amount M becomes larger.

For example, as normal paraffins, each having a large number of carbon atoms, are contained in a larger amount in a fuel, the fuel is less likely to vaporize and the viscosity thereof becomes higher, and hence there is the tendency that the adhesion index Y becomes high and the deposit amount M becomes large, although the soot generation index X does not become that high.

In the following Step S15, it is determined whether the deposit amount M is smaller than a predetermined amount TH stored in advance. When it is determined that the deposit amount M is smaller than the predetermined amount TH, the processing of FIG. 7 is ended, and the above-described control (normal control) by each of the injection control unit 83, the fuel pressure control unit 84, the EGR control unit 85, the supercharging pressure control unit 86, and the intake manifold temperature control unit 87 is continued as it is.

On the other hand, when it is determined that the deposit amount M is not smaller than the predetermined amount TH, the below-described deposit reduction control is executed in the following Step S16 so as to reduce the deposit amount M. For example, just after the internal combustion engine 10 is stopped, the EGR valve 17a is opened and closed. Thereby, the deposits that have adhered to the EGR valve 17a are shaken down, so that the deposit amount is reduced. Alternatively, when the opening and closing operations of the EGR valve 17a are always executed just after the internal combustion engine 10 is stopped, the number of times of the opening and closing operations is increased.

Alternatively, in at least one of the injection control unit 83, the fuel pressure control unit 84, the EGR control unit 85, the supercharging pressure control unit 86, and the intake manifold temperature control unit 87, the target values of the various control amounts related to the normal control are corrected so as to reduce a soot component. For example, the target value of the EGR amount related to the EGR control unit 85 is lowered, whereby the actual EGR amount is reduced. Alternatively, the target value of the intake manifold temperature related to the intake manifold temperature control unit 87 is lowered, whereby the actual intake manifold temperature is lowered. According to this, for example, the product life of the EGR cooler 17b can be extended.

In the following Step S17, both fuel information that is information on the mixing ratio of a molecular structure species and a control history that is a history of the deposit reduction control are stored in the microcomputer 80a. For example, the mixing ratio of a molecular structure species, which changes every time when a fuel is supplied, is recorded, and the control history is recorded in association with the recording.

Herein, the microcomputer 80a, while executing the processing of Step S11, corresponds to the “acquisition unit.” The microcomputer 80a, while executing the processing of Steps S12 and S13, corresponds to the “soot calculation unit” and the “adhesion index calculation unit”, respectively. The microcomputer 80a, while executing the processing of Step S14, corresponds to the “deposit amount estimation unit.” The microcomputer 80a, while executing the processes of Steps S16 and S17, corresponds to the “control unit.” The deposit estimation device is provided by the ECU 80 including the microcomputer 80a.

In the present embodiment, the acquisition unit, the soot calculation unit, the adhesion index calculation unit, and the deposit amount estimation unit in Steps S11, S12, S13, and S14 are provided, as described above. The acquisition unit acquires the mixing ratio of each of a plurality of types of molecular structures included in a fuel. The soot calculation unit calculates the soot generation index X, representing how likely a soot component is to be generated due to combustion, based on the mixing ratio acquired by the acquisition unit. The adhesion index calculation unit calculates the adhesion index Y, representing how likely an SOF component generated due to combustion is to adhere, based on the mixing ratio acquired by the acquisition unit. The deposit amount estimation unit estimates the deposit amount of the SOF component that has adhered to a predetermined portion of the combustion system based on the soot generation index X and the adhesion index Y.

According to the present embodiment, the acquisition unit, the soot calculation unit, and the adhesion index calculation unit are provided, and hence the soot generation index X and the adhesion index Y can be calculated based on the mixing ratio of each of a plurality of types of molecular structures, as described above. In addition to that, the deposit amount estimation unit is provided in the embodiment, and hence the deposit amount M can be estimated with high accuracy.

Further, in the present embodiment, the adhesion index calculation unit in Step S13 calculates the adhesion index Y to be a higher value as the mixing ratios of the respective a plurality of types of molecular structures are a combination of values at which the volatility of a fuel becomes lower. In addition, the adhesion index Y is calculated to be a higher value as the above mixing ratios are a combination of values at which the average number of carbon atoms of a fuel becomes larger.

Herein, the present inventors have obtained the knowledge that: the above mixing ratios correlate with the average number of carbon atoms of a fuel; the average number of carbon atoms also correlates with a distillation property (i.e., volatility); and as the volatility of a fuel is lower, the tackiness of an SOF component is higher. Therefore, according to the present embodiment in which when the above mixing ratios are a combination of values at which the volatility of a fuel becomes lower or at which the average number of carbon atoms becomes larger, the adhesion index Y is set to a higher value, the adhesion index Y can be estimated with high accuracy, and finally the deposit amount M can be estimated with high accuracy.

Also, the above mixing ratios correlate with a dynamic viscosity. Therefore, according to the present embodiment in which as the above mixing ratios are a combination of values at which the dynamic viscosity of a fuel is higher, the adhesion index Y is calculated to be a higher value, the adhesion index Y can be estimated with high accuracy, and finally the deposit amount M can be estimated with high accuracy.

Furthermore, in the present embodiment, the soot calculation unit in Step S12 calculates the soot generation index X to be a higher value as the mixing ratio of aromatic components contained in a fuel is larger. The soot component is formed with paraffin components or naphthene components, each having a large number of linear chains or side chains, subjected to polymerization through decomposition or with aromatic components subjected to polycyclization through polymerization and condensation. Therefore, according to the embodiment in which as the mixing ratio of aromatic components is larger, the soot generation index X is set to a higher value, the deposit amount M can be estimated with high accuracy. Herein, the decomposition includes thermal decomposition, decomposition by radicals, and the like, and strictly speaking, decomposition by radicals occurs after thermal decomposition occurs.

Herein, the molecular structure of a fuel, before being burned after being injected into the combustion chamber 11a, changes due to being exposed to a high temperature environment. One of the changes is that the below-described aromatic variable components polymerize through thermal decomposition or decomposition by radicals and change to aromatic components. Specific examples of the aromatic variable components include naphthenes, paraffins, and the like. Aromas have a cyclic structure having an unsaturated bond, and the aromatic variable components change to have such a structure.

For example, naphthenes have a cyclic structure, but do not have an unsaturated bond. Even such naphthenes may change to aromas as described below. That is, bonds between atoms may be partially broken due to thermal decomposition or the like and further hydrogen may be extracted by a hydrogen abstraction reaction, whereby the broken site may be bonded to another site, and as a result, naphthenes may change to have a cyclic structure having an unsaturated bond, that is, change to aromas. Paraffins do not have a cyclic structure, but they may change to have a cyclic structure having an unsaturated bond, that is, change to aromas by being subjected to polymerization through decomposition in the same way.

In the combustion chamber 11a, soot components are formed just before combustion with aromatic components subjected to polymerization, and most of the soot components disappear by combustion. When the soot component is taken into unburned fuel or lubricating oil, or when a polycyclic aromatic component, a soot precursor, remains unburned, an SOF component is generated. Therefore, as a larger amount of aromatic components are contained in a fuel, the amount of the SOF component becomes larger.

However, aromatic variable components may change to aromatic components just before combustion, as described above, and hence the amount of aromatic components may be large just before combustion, even for a fuel containing a small amount of aromatic components in a state of normal temperature. This means that even if the amount of aromatic components contained in a fuel is equal, the amount of the SOF component, that is, the deposit amount M differs when the amount of aromatic variable components differs.

In the present embodiment, the soot calculation unit in Step S12 calculates, based on the above knowledge, the soot generation index X to be a higher value, as the mixing ratio of aromatic variable components contained in a fuel is larger. Therefore, the soot generation index X is estimated also in consideration of a change in the molecular structure of a fuel, generated before combustion, and hence the deposit amount M can be estimated with high accuracy.

Still furthermore, in the present embodiment, at least naphthene components are included in the aromatic variable components to be used for the estimation of the soot generation index X. Among the various aromatic variable components, naphthene components are particularly likely to change to aromatic components. Therefore, according to the embodiment in which the amount of naphthene components is included in the amount of aromatic variable components to be used for the estimation of the soot generation index X, the accuracy of estimating the soot generation index X can be improved.

Still furthermore, in the present embodiment, at least naphthene components, each having a structure having two or more of cyclic structures, are included in the naphthene component to be used for the estimation of the soot generation index X. Among the naphthene components, naphthene components, each having a structure having two or more of cyclic structures, are particularly likely to change to aromatic components. Therefore, according to the embodiment in which the amount of naphthene components each having a structure having two or more of cyclic structures is included in the amount of aromatic variable components to be used for the estimation of the soot generation index X, the accuracy of estimating the soot generation index X can be improved.

Still furthermore, in the present embodiment, at least isoparaffin components are included in the aromatic variable components to be used for the estimation of the soot generation index X. Among the various aromatic variable components, naphthene components are particularly likely to change to aromatic components. Therefore, according to the embodiment in which the amount of isoparaffin components is included in the amount of aromatic variable components to be used for the estimation of the soot generation index X, the accuracy of estimating the soot generation index X can be improved.

Still furthermore, in the present embodiment, at least isoparaffin components, each having a structure having carbon atoms whose number is smaller than the average number of carbon atoms of a plurality of types of components contained in a fuel, are included in the isoparaffin components to be used for the estimation of the soot generation index X. Among the side chain paraffin components, the side chain paraffin components having a structure having a small number of carbon atoms are particularly likely to change to aromatic components. Therefore, according to the embodiment in which the amount of isoparaffin components, each having a structure having carbon atoms whose number is smaller than the average number of carbon atoms, is included in the amount of aromatic variable components to be used for the estimation of the soot generation index X, the accuracy of estimating the deposit amount M can be improved.

Still furthermore, in the present embodiment, a control unit, which controls the operation of the combustion system such that a deposit amount is reduced in accordance with the deposit amount estimated by the deposit amount estimation unit, that is, with the deposit amount M, is provided. According to this, reduction control is executed based on the deposit amount M estimated with high accuracy, and hence excess or deficiency of the reduction control can be suppressed.

Still furthermore, in the present embodiment, the combustion property acquisition unit 81 and the mixing ratio estimation unit 82 are provided. The combustion property acquisition unit 81 acquires the detected value of a physical quantity related to the combustion of the internal combustion engine 10 as the combustion property value. The mixing ratio estimation unit 82 estimates the mixing ratios of various components contained in a fuel based on a plurality of combustion property values detected under different combustion conditions.

Herein, even if exactly the same fuel is burned, combustion property values, such as an ignition delay time and the amount of heat generated, differ when the combustion conditions at the time, such as an in-cylinder pressure and an in-cylinder temperature, differ. For example, in the case of the fuel (1) in FIG. 4, the ignition delay time TD (combustion property value) becomes shorter as the combustion is performed under a condition in which the in-cylinder oxygen concentration is higher. A degree of change in the combustion property value with respect to a change in the combustion condition, that is, the property lines shown by the solid lines in FIG. 4 differ for each of the fuels (1), (2), and (3) in each of which the mixing ratio of each molecular structure species is different from the other two. In the present embodiment in which this point is taken into consideration, the mixing ratio of each molecular structure species contained in a fuel is estimated based on a plurality of the ignition delay times TD (combustion property values) detected under different combustion conditions, whereby the properties of the fuel can be grasped more accurately.

Still furthermore, in the present embodiment, the combustion condition is one specified by a combination of a plurality of types of combustion environment values. That is, for each of the plurality of types of combustion environment values, a combustion property value, occurring when combustion is performed under a condition in which a combustion environment value is different, is acquired. According to this, a mixing ratio can be estimated with higher accuracy than in the case where for the same type of combustion environment values, a combustion property value, occurring when combustion is performed under a condition in which the combustion environment values are different, is acquired such that a mixing ratio is estimated based on the combustion condition and the combustion property values.

Still furthermore, in the present embodiment, at least one of the in-cylinder pressure, the in-cylinder temperature, the intake oxygen concentration, and the fuel injection pressure is included in the plurality of types of combustion environment values related to the combustion conditions. According to the embodiment in which a mixing ratio is estimated by using combustion property values occurring when combustion is performed under a condition in which these combustion environment values are different, the mixing ratio can be estimated with high accuracy because these combustion environment values have a large influence on a combustion state.

Still furthermore, in the present embodiment, the combustion property value is the ignition delay time TD between when fuel injection is commanded and when the fuel self-ignites. According to the embodiment in which a mixing ratio is estimated based on the ignition delay time TD, the mixing ratio can be estimated with high accuracy because the ignition delay time TD is greatly influenced by the mixing ratios of various components.

Still furthermore, in the present embodiment, the combustion property acquisition unit 81 acquires a combustion property value related to the combustion of the fuel injected before the main injection (pilot injection). When the fuel of the main injection is burned, the in-cylinder temperature becomes high, and hence the fuel after the main injection is more likely to be burned. Therefore, a change in the combustion property value, occurring due to a difference between the mixing ratios in fuels, is less likely to appear. On the other hand, the fuel injected before the main injection (pilot injection) is not influenced by the main combustion, and hence a change in the combustion property value, occurring due to a difference between the mixing ratios in fuels, is more likely to appear. Therefore, in estimating a mixing ratio based on the combustion property values, the estimation accuracy can be improved.

### Second Embodiment

In the first embodiment, the mixing ratio estimation unit 82 estimates the mixing ratios of various components based on a plurality of the combustion property values. In the present embodiment, however, the general properties of a fuel are detected by property sensors, so that the mixing ratios are estimated based on the detection results.

Specific examples of the property sensors include a density sensor 27, a dynamic viscosity sensor 28, and the like. The density sensor 27 detects the density of a fuel based on, for example, a natural vibration period measuring method. The dynamic viscosity sensor 28 is, for example, a thin tube viscometer or a dynamic viscometer based on a thin wire heating method, and it detects the dynamic viscosity of the fuel in the fuel tank. The density sensor 27 and the dynamic viscosity sensor 28 include a heater, and detect the density and the dynamic viscosity of a fuel, respectively, in a state in which the fuel is heated to a predetermined temperature by the heater.

The present inventors have paid attention to the fact that: the specific property parameters of a fuel, in other words, the intermediate parameters correlate with the physical quantity of each molecular structure contained in a fuel composition; and a sensitivity to the molecular structure differs for each property parameter type. In other words, when a molecular structure differs in a fuel, bonding force between molecules, steric hindrance due to structure, interaction, and the like differ. In addition, a fuel contains a plurality of types of molecular structures, and the mixing ratios thereof differ from fuel to fuel. In this case, it is considered that a sensitivity contributing to a property parameter differs for each molecular structure, and hence the value of a property parameter changes depending on the amount of a molecular structure.

The present inventors have established a correlation equation for the property parameters and the molecular structures. This correlation equation is an arithmetic expression of a property calculation model by which a plurality of property parameters are derived by using sensitivity coefficients indicating degrees of dependence of the amounts of a plurality of molecular structures on a plurality of the property parameters and by reflecting the sensitivity coefficients on the amounts of the molecular structures. The amount of a molecular structure contained in a fuel composition can be calculated by inputting, as the values of the property parameters, the values detected by the property sensors to the correlation equation.

In addition, a lower calorific value correlates with the dynamic viscosity and density of a fuel, and hence it can be calculated based on the dynamic viscosity and the density by using a map or an arithmetic expression representing the correlation. The lower calorific value thus calculated may be used as a property parameter to be inputted to the correlation equation.

In addition, a ratio (HC ratio) of the amount of hydrogen to the amount of carbon, which are contained in a fuel, correlates with a lower calorific value, and hence the HC ratio can be calculated based on the lower calorific value by using a map or an arithmetic expression representing the correlation. The HC ratio thus calculated may be used as a property parameter to be inputted to the correlation equation. Other than these, a parameter related to cetane number or distillation property can also be used as the property parameter.

According to the present embodiment, a plurality of property parameters indicating the properties of a fuel are acquired as described above. Then, the amounts of a plurality of molecular structures, that is, the mixing ratio of each molecular structure species is estimated by using correlation data defining correlations between a plurality of property parameters and the amounts of a plurality of molecular structures in a fuel and based on the acquired values of the plurality of property parameters that have been acquired. Therefore, the mixing ratios or the intermediate parameters of molecular structure species, which are to be used for the estimation of the deposit amount M, can be acquired by using the values detected by the property sensors, without using the value detected by the in-cylinder pressure sensor 21.

### Third Embodiment

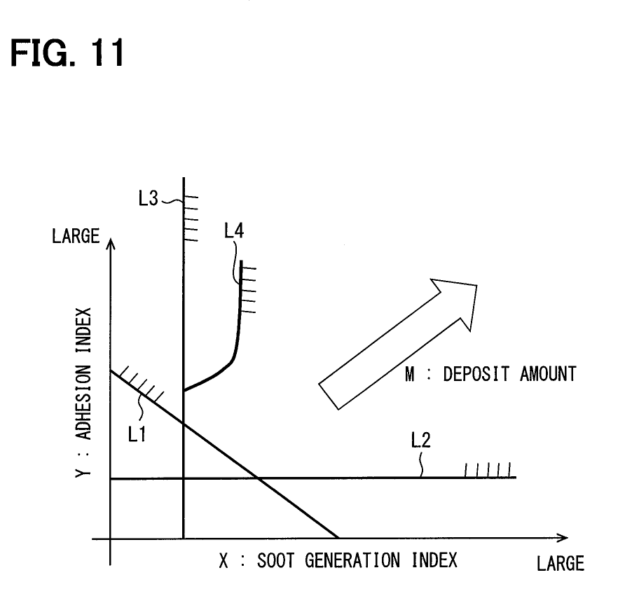

In the first embodiment, in calculating the deposit amount M based on the soot generation index X and the adhesion index Y, the boundary line of the lower limit range where soot is generated is defined by one boundary line L1, as shown in FIG. 10. In the present embodiment, however, a lower limit range where soot is generated is defined by four boundary lines L1, L2, L3, and L4, as shown in FIG. 11. The boundary line L1 is the same as the boundary line L1 in FIG. 10. The boundary line L2 indicates the lower limit value of the adhesion index Y and is a value set regardless of the value of the soot generation index X. The boundary line L3 indicates the lower limit value of the soot generation index X and is a value set regardless of the value of the adhesion index Y. Herein, a fuel, having a low soot generation index X and a high adhesion index Y, cannot exist. The boundary line L4 sets such a region where no fuel can exist as a boundary of the lower limit range.

According to the present embodiment, the lower limit range of the deposit amount M is set by the four types of the boundary lines L1, L2, L3, and L4, each having a technical meaning, as described above, and hence in calculating the deposit amount M based on the soot generation index X and the adhesion index Y, the calculation accuracy can be improved.

### Fourth Embodiment

In the first embodiment, the adhesion index Y is calculated based on the mixing ratio of each molecular structure species by the adhesion index calculation unit in Step S13 of FIG. 7. In the present embodiment, however, the adhesion index Y is calculated based on the value detected by the dynamic viscosity sensor 28. As the detected dynamic viscosity is higher, an SOF component is more likely to adhere, so that the adhesion index Y is calculated to be a higher value. The adhesion index Y is calculated, for example, by substituting the value detected by the dynamic viscosity sensor 28 into an arithmetic expression using a dynamic viscosity as a variable, instead of the arithmetic expression of FIG. 9. Herein, the soot generation index X is calculated based on the mixing ratio in the same way as in the first embodiment. The method of calculating the deposit amount M from both the indices is also the same as in the first embodiment.

According to the present embodiment, the adhesion index calculation unit in Step S13 calculates the adhesion index Y to be a higher value as the dynamic viscosity of a fuel detected by the dynamic viscosity sensor 28 is higher, as described above. Since the correlation between a dynamic viscosity and the adhesion index Y is high, the adhesion index Y can be accurately calculated in the same way as in the first embodiment and finally the deposit amount M can be accurately calculated, also according to the embodiment.

### Other Embodiments

Although the preferred embodiments of the invention have been described above, the invention is not limited to the above-described embodiments at all, and various modifications can be made as exemplified below. Not only combinations of parts that clearly indicate that combinations are specifically possible in each embodiment, but also partial combinations of the embodiments are possible when there is no particular obstruction to the combinations, even if not explicitly stated.

In the embodiment shown in FIG. 9, the adhesion index Y is calculated by substituting the mixing ratio of each molecular structure species into the arithmetic expression. On the other hand, an arithmetic expression may be set such that: an intermediate parameter, such as a distillation property T50 or a dynamic viscosity, is estimated from the mixing ratio of each molecular structure species; and the adhesion index Y is calculated by substituting the estimated value into the arithmetic expression.

The adhesion index Y is calculated based on the value detected by the dynamic viscosity sensor 28 in the fourth embodiment; however, the adhesion index Y may be calculated based on the fuel property detected by another sensor such as the density sensor 27. Alternatively, the adhesion index Y may be calculated by estimating a dynamic viscosity by paying attention to the fact that the mixing ratio of each molecular structure species correlates with a dynamic viscosity, and then based on the estimated value.

In the embodiment shown in FIG. 2, the time between the timing t1 at which powering is started and the timing t3 at which combustion is started is defined as the ignition delay time TD. On the other hand, the time between the timing t2 at which injection is started and the timing t3 at which combustion is started may be defined as the ignition delay time TD. The timing t2 at which injection is started may be estimated by detecting a timing, at which a change in the fuel pressure such as the rail pressure occurs with the start of injection and based on the detected timing.

The combustion property acquisition unit 81 shown in FIG. 1 acquires the ignition delay time TD as the detected value (i.e., combustion property value) of a physical quantity related to combustion. On the other hand, the combustion property acquisition unit 81 may acquire, as the combustion property values, a waveform representing a change in the heat generation rate, an amount of heat (amount of heat generated) generated by the combustion of a corresponding fuel, and the like. In addition, the mixing ratios of various components may be estimated based on a plurality of types of combustion property values such as the ignition delay time TD, the waveform of heat generation rate, and the amount of heat generated. For example, the matrix (constants) on the left side of the right side in FIG. 3 are set to values corresponding to the plurality of types of combustion property values, and the plurality of types of combustion property values are substituted into the matrix on the right side of the right side in FIG. 3, whereby the mixing ratios are estimated.

In the example of FIG. 3, the combustion conditions are set such that all of the combustion environment values are different for each of the plurality of the ignition delay times TD. That is, for the respective combustion conditions i, j, k, and l (see FIG. 3) each formed of a predetermined combination of the combustion environment values, all of the in-cylinder pressures are set to different values P (condition i), P (condition j), P (condition k), and P (condition l). Similarly, all of the in-cylinder temperatures T, all of the intake oxygen concentrations O₂, and all of the injection pressures Pc are set to different values. On the other hand, for the respective different combustion conditions, at least one of the combustion environment values may be different. For example, for the respective combustion conditions i and j, all of the in-cylinder temperatures T, all of the intake oxygen concentrations O₂, and all of the injection pressures Pc are set to the same value, and only the in-cylinder pressures may be set to different values P (condition i) and P (condition j).

In the above-described embodiments, combustion property values related to the combustion of the fuel injected just before the main injection (pilot injection) are acquired. On the other hand, combustion property values related to the combustion of the fuel injected after the main injection may be acquired. Specific examples of the injection after the main injection include after-injection and post-injection. When multi-stage injection, in which injection is performed more than once before the main injection, is performed, it is preferable to acquire combustion property values related to the combustion of the fuel injected for the first time, because the combustion is not greatly influenced by the main combustion.

In the above-described embodiments, combustion property values are acquired based on the values detected by the in-cylinder pressure sensor 21. On the other hand, in a configuration not including the in-cylinder pressure sensor 21, combustion property values may be estimated based on the rotational fluctuation (differential value of the rotation number) of a rotation angle sensor. For example, the timing, at which the differential value exceeds a predetermined threshold value due to the pilot combustion, can be estimated as a pilot ignition timing. In addition, a pilot combustion amount can be estimated from the magnitude of the differential value.

In the embodiment shown in FIG. 1, the in-cylinder temperature is detected by the temperature detection element 21a, but the in-cylinder temperature may be estimated based on the in-cylinder pressure detected by the in-cylinder pressure sensor 21. Specifically, the in-cylinder temperature is estimated from the calculation using the in-cylinder pressure, the cylinder volume, the gas weight in the cylinder, and the gas constant.

In the control shown in FIG. 7, the deposit reduction control for controlling the operation of the combustion system is performed in Step S16, in which the deposit amount M is reduced in accordance with the deposit amount M estimated by the deposit amount estimation unit in Step S14. On the other hand, the control unit in Step S16 may be omitted. In this case, when it is determined that the deposit amount M is equal to or larger than the predetermined amount TH, it is desirable to record fuel information and the like in Step S17 and to notify a driver of the abnormality by an alarm or display.

Means and/or functions provided by the ECU 80 (combustion system control device) can be provided by software recorded on a substantive storage medium, computer executing the software, software only, hardware only, or a combination thereof. For example, when the combustion system control device is provided by a circuit that is hardware, it can be provided by a digital circuit or an analog circuit including many logic circuits.

Although the present disclosure has been described in accordance with embodiments, it is understood that the disclosure should not be limited to the embodiments and structures. The present disclosure encompasses various modifications and variations within the equivalent scope. In addition, various combinations and forms, as well as other combinations and forms including, in them, only one element, more than one, or less, are also within the scope and idea of the disclosure.

1. A deposit estimation device comprising:
an acquisition unit that acquires a mixing ratio of each of a plurality of types of molecular structures included in a fuel to be used for combustion of a combustion system;
a soot calculation unit that calculates a soot generation index, representing how likely a soot component is to be generated due to combustion, based on the mixing ratio acquired by the acquisition unit;
an adhesion index calculation unit that calculates an adhesion index, representing how likely a soluble organic component generated due to combustion is to adhere, based on a value detected by a sensor for detecting a property of a fuel or the mixing ratio acquired by the acquisition unit; and
a deposit amount estimation unit that estimates a deposit amount of a soluble organic component that has adhered to a predetermined portion of the combustion system, based on the soot generation index calculated by the soot calculation unit and the adhesion index calculated by the adhesion index calculation unit.

2. The deposit estimation device according to claim 1, wherein
the adhesion index calculation unit calculates the adhesion index to be a value indicating that the soluble organic component is more likely to adhere, as the mixing ratios of the plurality of types of molecular structures acquired by the acquisition unit are a combination of values at which the volatility of a fuel becomes lower.

3. The deposit estimation device according to claim 1, wherein
the adhesion index calculation unit calculates the adhesion index to be a value indicating that the soluble organic component is more likely to adhere, as the mixing ratios of the plurality of types of molecular structures acquired by the acquisition unit are a combination of values at which an average number of carbon atoms of a fuel is larger.

4. The deposit estimation device according to claim 1, wherein
the adhesion index calculation unit calculates the adhesion index to be a value indicating that the soluble organic component is more likely to adhere, as the mixing ratios of the plurality of types of molecular structures acquired by the acquisition unit are a combination of values at which a dynamic viscosity of a fuel is higher.

5. The deposit estimation device according to claim 1, wherein
the soot calculation unit calculates the soot generation index to be a value indicating that the soot component is more likely to be generated, as, among the mixing ratios of the plurality of types of molecular structures acquired by the acquisition unit, the mixing ratio of aromatic components is larger.

6. The deposit estimation device according to claim 1, wherein
when among the components contained in the fuel, components, each forming an aromatic component by being subjected to polymerization through decomposition before combustion, are referred to as aromatic variable components, and
the soot calculation unit calculates the soot generation index to be a value indicating that the soot component is more likely to be generated, as, among the mixing ratios of the plurality of types of molecular structures acquired by the acquisition unit, the mixing ratio of the aromatic variable components is larger.

7. A combustion system control device comprising:
an acquisition unit that acquires a mixing ratio of each of a plurality of types of molecular structures included in a fuel to be used for combustion of a combustion system;
a soot calculation unit that calculates a soot generation index, representing how likely a soot component is to be generated due to combustion, based on the mixing ratio acquired by the acquisition unit;
an adhesion index calculation unit that calculates an adhesion index, representing how likely a soluble organic component generated due to combustion is to adhere, based on a value detected by a sensor for detecting a property of a fuel or the mixing ratio acquired by the acquisition unit;
a deposit amount estimation unit that estimates a deposit amount of a soluble organic component that has adhered to a predetermined portion of the combustion system, based on the soot generation index calculated by the soot calculation unit and the adhesion index calculated by the adhesion index calculation unit; and
a control unit that controls the operation of the combustion system so as to reduce the deposit amount in accordance with the deposit amount estimated by the deposit amount estimation unit.
